(19) United States
(12) Patent Application Publication
(10) Pub. No.: US 2018/0244493 A1
(43) Pub. Date: Aug. 30, 2018

(54) ELEVATOR PASSENGER ALLOCATION ARRANGEMENT

(71) Applicants: Ari Hanninen, Helsinki (FI); Otto Miettinen, Helsinki (FI); Hannu Nousu, Helsinki (FI); Kirsi Nyrhinen, Helsinki (FI); Markku Haivala, Helsinki (FI); Reetta Ranne, Espoo (FI); Cristina Bianchi, Helsinki (FI); Nithil Karimpanackal Natarajan, Helsinki (FI)

(72) Inventors: Ari Hanninen, Helsinki (FI); Otto Miettinen, Helsinki (FI); Hannu Nousu, Helsinki (FI); Kirsi Nyrhinen, Helsinki (FI); Markku Haivala, Helsinki (FI); Reetta Ranne, Espoo (FI); Cristina Bianchi, Helsinki (FI); Nithil Karimpanackal Natarajan, Helsinki (FI)

(73) Assignee: Kone Corporation, Helsinki (FI)

(21) Appl. No.: 15/969,981

(22) Filed: May 3, 2018

Related U.S. Application Data
(63) Continuation of application No. PCT/FI2015/050772, filed on Nov. 9, 2015.

(51) Int. Cl. B66B 3/00; B66B 1/46

(52) U.S. Cl. CPC B66B 3/006; B66B 2201/4615; B66B 1/468

(57) ABSTRACT

Passenger allocation in elevator systems is a critical task if efficient use of elevator system is desired. It is advantageous to optimize the overall capacity of an elevator system by using optimizing systems. One key issue in optimization is to guide passengers to act according to optimization result. This can be provided by indicating a color to each passenger so that they can choose an elevator indicating the same color.

This application is a continuation of PCT International Application No. PCT/FI2015/050772 which has an International filing date of Nov. 9, 2015, the entire contents of which are incorporated herein by reference.

### DESCRIPTION OF BACKGROUND

Passenger allocation in elevator systems is a critical task when the elevator capacity needs to be used optimally. This is particularly the case in high buildings where the number of elevators used and passengers is high. There are several solutions that may be applied so that the space required for elevators is used optimally.

For example, in a high building there may be conventional elevators that can access only some floors. It is common that some of the elevators stop only in predetermined floors or they do not stop below a predetermined floor level. This will allow everybody to travel to the destination floor with limited number of stops during the journey.

Another very common tool for reducing the problems mentioned above is a destination control system. In such system the passengers indicate the destination floor where they are wishing to travel and the system indicates the elevator that is allocated for the passenger. In this manner it is possible to collect passengers into groups so that the overall performance of the elevator system is optimized.

In addition to the arrangements on conventional elevators or allocation methods it is also possible to use multi-car elevator systems. A multi-car elevator system typically comprises two elevator shafts and larger number of elevator cars. The first shaft may be used for elevator cars going up and the second shaft for elevator cars going down. The actual number of cars in such system naturally depends on the height of the building. Multi-car arrangement provides more efficient use of an elevator shaft because of a larger number of cars.

The above mentioned solutions are examples for enabling more efficient elevator systems and it is possible that they are implemented together so that the overall capacity of the elevator system is improved. For example, conventional elevators may be used as express elevators to higher floors and multi-car elevators to distribute the passengers to the final destinations from an arrival floor of the express elevator.

Even with the solutions mentioned above and other efforts to optimize the elevator usage there is a continuous need for new solutions because new higher buildings are built and even more passengers are travelling to floors of new high buildings. Furthermore, it is an object for building constructors to use less space for the elevator systems because the space in high buildings is expensive and all space must be used efficiently.

One of the critical issues in the optimization process is the passenger instructions and the passenger behavior following the instructions. The instructions for passengers must be generated in a manner that passengers are efficiently allocated but also guided to elevator cars according to the allocation. Thus, the guidance must be arranged in a manner that the instructions given to passengers are easy to follow so that the effect of the passenger behavior is minimized.

### SUMMARY

Passenger allocation in elevator systems is a critical task if efficient use of elevator system is desired. It is advantageous to optimize the overall capacity of an elevator system by using optimizing systems. One key issue in optimization is to guide passengers to act according to optimization result. This can be provided by indicating a color to each passenger so that they can choose an elevator indicating the same color.

In an embodiment a method for elevator passenger allocation in an arrangement comprising a plurality of elevators is disclosed. In the method an elevator call is received. Then the current state of said arrangement is retrieved and the received elevator call is processed. Then new state of said arrangement based on said processed elevator call and said retrieved state is and said new state is displayed to elevator passengers.

In a further embodiment the displaying said new state to elevator passengers is performed by indicating a color. In a further embodiment indication is performed by showing different colors on an elevator door frame or display. In a further embodiments colors are shown in different shades or are combined with text for providing secondary information comprising at least one of the following: estimated time of arrival at the present floor, occupancy, called floors for said elevator car and estimated time of arrival at last called floor.

In an embodiment embodiments discussed above are implemented as a computer program that is executing on an apparatus controlling an elevator group. The computing device comprises at least one processor, at least one memory and at least one data communication connection.

In a further embodiment the apparatus is connected with an elevator group. In an embodiment an elevator arrangement comprising the apparatus and a plurality of elevators is disclosed. The elevator arrangement may further comprise a door frame for an elevator, wherein at least portion of the door frame is configured to indicate a color corresponding with an allocated elevator ride. The elevator arrangement may further comprises a display associated with a door frame for an elevator, wherein said display is configured to indicate a color corresponding with an allocated elevator ride.

In a further embodiment the elevator arrangement further comprises a control device and a display, wherein in said display is configured to indicate a color corresponding with said allocated elevator ride. In another embodiment front wall of elevator shafts in said elevator group is made of glass.

The benefits of the elevator passenger allocation discussed above includes enabling the passengers to follow the optimization results easily so that elevator cars are loaded according to the optimization results because the state of the system is shown to passengers.

### BRIEF DESCRIPTION OF THE DRAWINGS

The accompanying drawings, which are included to provide a further understanding of the elevator passenger allocation arrangement and constitute a part of this specification, illustrate embodiments and together with the description help to explain the principles of the elevator passenger allocation arrangement. In the drawings:

FIG. 1 is a block diagram of an elevator passenger allocation arrangement, and

FIG. 2 is a flow diagram of a method implementing elevator passenger allocation.

### DETAILED DESCRIPTION

Reference will now be made in detail to the embodiments, examples of which are illustrated in the accompanying drawings.

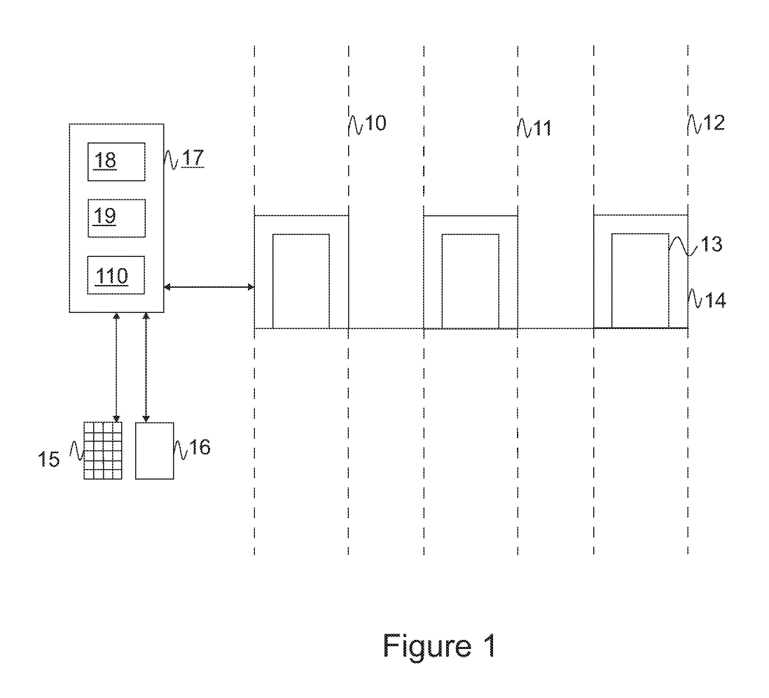

In FIG. 1 a block diagram of an elevator passenger allocation arrangement is disclosed. In the figure three elevator shafts 10-12 are disclosed. The shafts can be used to host any known elevator arrangements. For example, elevator shafts 10 and 11 may be reserved for a multi-car configuration and elevator 12 is a conventional elevator that is typically used as an express elevator to higher floors but can also stop at any given floor. Even if in the figure only three elevators are shown it is typical that higher buildings typically have more and they may be distributed into several different lobbies.

In the figure a door 13 associated with elevator shaft 12 and a door frame 14 associated with the door 13 are shown. It is assumed that in the embodiment of FIG. 1 other elevator shafts 10 and 11 have similar arrangements. Door arrangement 13 may be a conventional door made of metal, however, it is also possible to use at least partially transparent door systems. If transparent doors are used at floors it may be convenient to use only partially transparent doors at the elevator side. For example, the lower part of the elevator side doors may be shaded or made of completely non-transparent material for protecting privacy. Typically these doors are sliding doors in modern elevator installations but any suitable door type may be used.

In the embodiment of figure the door frame 14 is used for displaying information by means of different colors. The color of the frame can be changed and shown in different shades. This may be implemented by different ways. For example, on the top the frame a plurality of LED-devices of different colors may be installed so that it is possible to choose between different colors, such as blue, red or green. Another option is to provide lighting device inside the frame so that the frame is made of material through which the colors can be seen, for example of transparent or white plastic. Furthermore, it is possible to project the desired color by a projector. Any suitable means for providing color changing frame or frame parts are acceptable. Furthermore, even if in the embodiment of FIG. 1 the whole frame is assumed to change the color it is possible to provide embodiments wherein only a portion of the frame changes the color, however, the color changing portion should be large enough that passengers can see that without any problems.

In FIG. 1 a control panel of a destination control system 15 for choosing a destination floor is shown. An information screen 16 is provided into the vicinity of the destination control system. When a passenger chooses a floor a color corresponding with the floor is shown on the information screen 16. The color represents the current state of the system. For example, at the current state green color may be associated with the chosen destination floor. Thus, after choosing the floor associated with green color green is shown on information screen 16 and on at least one of the frames of the elevator system. Thus, the passenger can immediately recognize the elevator that is the best possible choice. For example, there may be more than one elevator going to that floor, however, the one indicated is having fewer stops. Even if only one control panel 15 is shown it is obvious that there may be more than one. In an alternative embodiment the color is only shown when elevator cars are arriving at the floor. Thus, the elevator system can make the allocation decision at the latest possible moment and no incorrect information will be shown to passengers.

In FIG. 1 a control device 17 comprising at least one processor 18, at least one memory 19 and at least one date communication connection 110, is shown. The at least one memory is configured to store computer program code and data related to the computer programs executed in the control device. The data comprises, for example, state of the elevator system. The at least one processor is configured to execute computer programs that can be used for controlling an elevator system. The at least one data communication connection is configured to communicate with different components and external systems.

The control device is configured to control the operation of the elevator group as explained later in detail. However, in principle, the control device is configured to receive calls from control panel 15. In addition to the called floor the call may include the number of passengers. Based on the calls the controller receives the current state of the system, processes the new call or calls, produces a new state for the system including new allocations expected to happen soon, produces display information in accordance with the new state for executing new allocations and displays the new state by means of different colors in door frames.

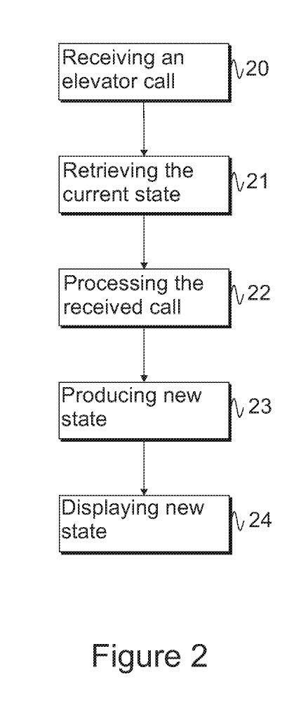

In FIG. 2 a method according to an embodiment is disclosed. The method is implemented in an elevator system comprising a plurality of elevators. In the method first an elevator call is received, step 20. Typically in high buildings elevator calls are received through a destination control system, however, ordinary or automated calling systems may be used. In an automated calling system the call may be placed, for example, by determining that a person has arrived to the elevator lobby and does not leave it so that it can be interpreted that the person is waiting for an elevator and an automated call can be placed. After receiving the call current state of the elevator system is retrieved, step 21. The current state includes all processed and allocated calls. Thus, the state may include calls that are currently have been placed before and the passenger is already in an elevator car but also those calls that have been processed and the passenger is waiting for the correct elevator car to arrive to the lobby where the passenger is waiting.

Based on the retrieved status the received call can be processed, step 22. The processing includes determining the possible allocations for placed call. With determined possibilities a new state is produced, step 23. The new state includes newly added calls and thus represents the current state after the calls have been processed. Based on the state it is possible to guide passengers to a correct elevator, which may be indicated by displaying a new color near the calling device and in a frame of the elevator, step 24, so that the passenger recognizes the color assigned for the call and can choose the right elevator. Even if the frame of the allocated elevator is mentioned here, it is not necessary to show the state of the system in the frame itself but there may be an additional means for showing the color in the vicinity of the elevator door. The means of showing can be arranged onto a frame, doors, control devices or other components that are close enough so that a person can recognize the indication and to which elevator it is associated. The additional means, such as a plurality of led-lights, screen, adjustable lighting device or similar needs to be close enough to the door so that the passenger understands which door is indicated. Furthermore, when an additional screen or display is used it is possible to show other information on that display instead of a color. Thus, it is possible that only some of the doors are equipped with colors and screens associated with elevators to which passengers are not guided may be used for displaying other information, such as date and time, advertisements or other information messages.

In the above discussed embodiments only use of colors has been disclosed, however, it is possible to use different shades of colors or progressing bars of particular color to indicate, for example, the estimated arrival time or occupancy of the respective elevator car or similar. For example, if the person can see the occupancy from the color and the progress of the elevator in a number it is possible to consider if an elevator car having more space but arriving a bit later would be more convenient. Furthermore, in case of a display device it is possible to combine text with said color information, for example, by using a colored background for the text. For example, it is possible to display all called floors on the display having a background color according to principles described above.

Even if in embodiments disclosed above destination control system is used it is not essential. In another embodiment the colors may be assigned to certain floors permanently and the allocation may be based on machine vision application, statistics or similar. For example, if a passenger is having an office in floor 42, he or she will always travel there. Instead of placing a call a color, for example green, may be assigned for the floor. Thus, every time the passenger arrives at the lobby in lower floors he or she may take any elevator having green color. Correspondingly elevators going back to the main lobby may be equipped with a color in higher floors. It may be beneficial that persons going to main lobby are instructed to a different elevator than those going to, for example, parking levels located below main lobby. Thus, the state information discussed above is not only relevant for passengers going up but it may be used also for downward direction.

The above discussed method may be implemented as computer software which is executed in a computing device able to communicate with a mobile device. When the software is executed in a computing device it is configured to perform the above described inventive method. The software is embodied on a computer readable medium so that it can be provided to the computing device, such as the control device 17 of FIG. 1.

As stated above, the components of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Common forms of computer-readable media can include, for example, a floppy disk, a flexible disk, hard disk, magnetic tape, any other suitable magnetic medium, a CD-ROM, CD±R, CD±RW, DVD, DVD-RAM, DVD±RW, DVD±R, HD DVD, HD DVD-R, HD DVD-RW, HD DVD-RAM, Blu-ray Disc, any other suitable optical medium, a RAM, a PROM, an EPROM, a FLASH-EPROM, any other suitable memory chip or cartridge, a carrier wave or any other suitable medium from which a computer can read.

It is obvious to a person skilled in the art that with the advancement of technology, the basic idea of the elevator passenger allocation arrangement may be implemented in various ways. The elevator passenger allocation arrangement and its embodiments are thus not limited to the examples described above; instead they may vary within the scope of the claims.

1. A method for elevator passenger allocation in an arrangement comprising a plurality of elevators comprising:
receiving an elevator call;
retrieving the current state of said arrangement;
processing said received elevator call;
producing new state of said arrangement based on said processed elevator call and said retrieved state; and
displaying said new state to elevator passengers.

2. A method according to claim 1, wherein displaying said new state to elevator passengers by indicating a color.

3. A method according to claim 2, wherein said color is indicated by producing different colors on an elevator door frame.

4. A method according to claim 2, wherein said color is indicated by producing different colors on an additional display associated with an elevator door.

5. A method according to claim 2, wherein the color is shown in different shades for providing secondary information.

6. A method according claim 5, wherein said color is used as a background color on a display device and the method further comprises providing text information on said display device.

7. A method according to claim 5, wherein said secondary information comprises at least one of the following: estimated time of arrival at the present floor, occupancy, called floors for said elevator car and estimated time of arrival at last called floor.

8. A method according to claim 1, wherein displaying said new state to elevator passengers when an elevator car arrives at the calling floor.

9. A method according to claim 1, wherein displaying said new state to elevator passengers immediately when said new state has been produced.

10. A computer program comprising code adapted to cause the method according to claim 1 when executed on a data-processing system.

11. An apparatus comprising:
at least one processor configured to execute computer programs;
at least one memory configured to store computer program code and data; and
at least data communication connection configured to communicate with external devices;
wherein said apparatus is configured to perform a method according to claim 1.

12. A system comprising:
an elevator group comprising a plurality of elevators; and
an apparatus according to claim 11.

13. A system according to claim 12, wherein said system further comprises at least one door frame for an elevator, wherein at least portion of said door frame is configured to indicate a color corresponding with an allocated elevator ride.

14. A system according to claim 12, wherein said system further comprises a display associated with a door frame for an elevator, wherein said display is configured to indicate a color corresponding with an allocated elevator ride.

15. A system according to claim 12, wherein said system further comprises a control device and a display, wherein in said display is configured to indicate a color corresponding with said allocated elevator ride.

16. A system according to claim 12, wherein front wall of elevator shafts in said elevator group is made of glass.
